(19) United States
(12) Patent Application Publication
(10) Pub. No.: US 2013/0187070 A1
(43) Pub. Date: Jul. 25, 2013

(54) LINK LINER

(71) Applicant: Francis P. Marocchini, Somers, CT (US)

(72) Inventor: Francis P. Marocchini, Somers, CT (US)

(73) Assignee: HAMILTON SUNDSTRAND CORPORATION, Windsor Locks, CT (US)

(21) Appl. No.: 13/354,741

(22) Filed: Jan. 20, 2012

(51) Int. Cl. F16K 31/44; B23P 17/04; B32B 3/24

(52) U.S. Cl. 251/279; 428/131; 29/527.2

(57) ABSTRACT

A protective liner for a link in an actuation system includes a link with a pin bore; and a liner layer on a inner surface of a pin bore of a link for an actuation system, wherein the liner material has modulus of elasticity of less than 1×10⁵ and a load carrying capability of at least 10 Ksi (68.95 N/mm²).

### BACKGROUND

The present invention relates to pneumatic air valves. In particular, the invention relates to actuator assemblies for pneumatic air valves.

Pneumatic air valves, sometimes called butterfly valves, in gas turbine engines typically include linkage systems. The actuator portion of the pneumatic air valve is cantilevered off the valve body to maintain a light-weight and simple construction. A linkage system is used to translate axial motion in the piston into a rotation of a disk to open or close the valve.

Linkage systems typically include two primary parts: a crank and a link. The crank and link are pinned together with a close-fit metallic pin. The crank can resemble a tuning fork like or clevis structure with a sleeve and two extending arms to connect above and below a link. The crank and the link can then be pinned together with a close fit metallic pin.

### SUMMARY

A protective liner for a link in an actuation system includes a link with a pin bore; and a liner layer on a inner surface of a pin bore of a link for an actuation system, wherein the liner material has a modulus of elasticity of less than 1×10⁵ Psi and a load carrying capability of at least 10 Ksi (68.95 N/mm²).

A method of forming a liner on a link includes providing a link having a pin bore; and depositing a liner material on the inner surface of the bore, wherein the liner material has a modulus of elasticity of less than 1×10⁵ and a load carrying capability of at least 10 Ksi (68.95 N/mm²).

### BRIEF DESCRIPTION OF THE DRAWINGS

FIG. 1A is perspective view of a pneumatic air valve.

FIG. 1B is a cross-sectional view of FIG. 1A.

FIG. 2A is a perspective view of a linkage system.

FIG. 2B depicts cross-axis rotation of the link about the pin.

FIG. 2C is a cross-sectional view of connection between crank and link of the linkage system of FIG. 2A.

### DETAILED DESCRIPTION

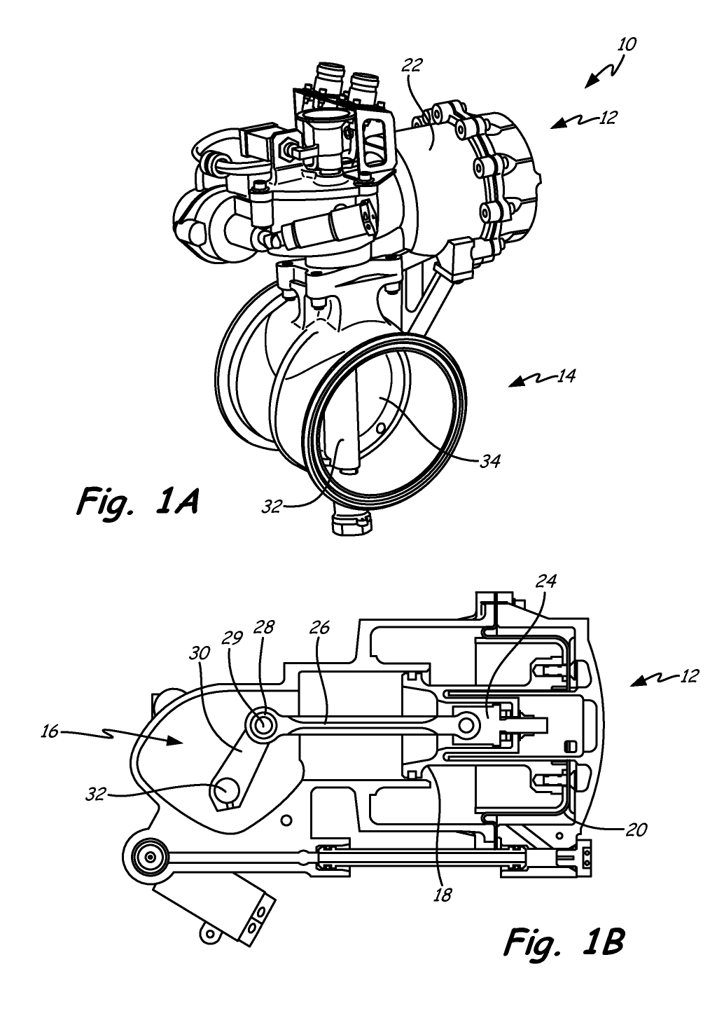

FIGS. 1A and 1B illustrate a pneumatic air valve incorporating the present invention. Pneumatic air valve 10 includes actuator assembly 12 and valve 14. Actuator assembly 12 includes linkage system 16, small piston 18, large piston 20 and actuator housing 22. Linkage system 16 includes clevis 24, link 26, bushing 28, bolt 29, crank 30 and shaft 32. Valve 14 includes disk 34, which is connected to and rotates with shaft 32.

Small piston 18 and large piston 20 connect to link 26 through clevis 24. Link 26 connects to crank 30 through bushing 28, with link 26, crank 30 and bushing 28 held in place by bolt 29. Crank 30 connects to shaft 32 through a fixed connection. Shaft 32 connects to disk 34 of valve 14.

Small piston 18 and large piston 20 move laterally based on a pneumatic signal. Clevis 24 translates that movement to lateral movement of link 26. The movement of link 26 causes crank 30 to rotate, which causes shaft 32 to rotate about an axis defined by shaft 32. The rotation of shaft 32 causes disk 34 of valve 14 to open or close.

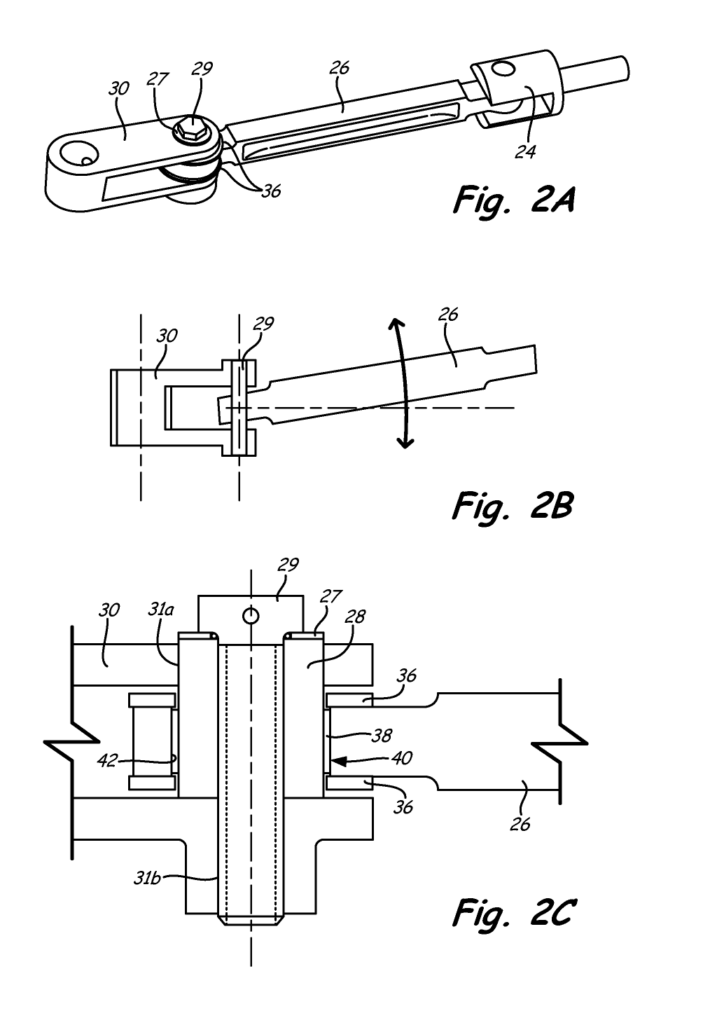

FIG. 2A is a perspective view of linkage system 16. FIG. 2B is a cross-sectional view of crank 30 and link 26, showing cross-axial rotation. FIG. 2C is a cross-sectional view of connection between crank 30 and link 26. FIGS. 2A-2C include linkage system 16 with clevis 24, link 26, washer 27, bushing 28, bolt 29, crank 30 (with upper pin bore 31a and lower pin bore 31b), spacers 36, and liner 38. Link 26 includes pin bore 40 with inner surface 42.

Crank 30 includes two arms with upper and lower bores through holes to line up with link 26 pin bore 40. Upper bore 31a of crank 30 holds bushing 28 and lower bore is typically threaded to hold bolt 29 directly. Bolt 29 acts as a pin and fits through bushing 28 in pin bore 40 of link 26 and pin bore 31 of crank 30, securing link 26 to crank 30. Liner 38 is attached on the inner surface 42 of pin bore 40 in link 26. Spacers 36 can be plastic and sit on top and bottom of link 26 to protect link 26 from vibrations in the axial direction.

Liner 38 can be made of a filled plastic material which has a low modulus of elasticity, for example less than 1×10⁵ Psi and a load carrying capability of at least 10 ksi (68.95 N/mm²). An example of a material that can be used in liner is filled Teflon. Liner 38 can be sprayed onto inner surface 42 of link 26 pin bore 40, with the center then machined out. Alternatively, liner 38 can be molded or bonded to inner surface 42 of liner 26 pin bore 40. Liner can vary in thickness depending on the material composition used. For example, in a specific embodiment, liner thickness can be about 0.01 inches (about 0.254 mm) to about 0.015 inches (about 0.381 mm) thick.

As mentioned above, to maintain a light weight system, actuator assembly 12 of pneumatic air valve 10 is cantilevered off the valve body and connected by linkage system 16. This arrangement makes actuator assembly 12 susceptible to vibrations. Vibrations from valve 14 can be amplified within actuator assembly 12, causing great cross-axial rotation in link 26, as seen in FIG. 2B. This rotation can causing fretting and galling in connections, especially on inner surface 42 of first connection end 40 between crank 30 an link 26. Past systems used close-fit metallic pieces to connect crank 30 to link 26. These connections resulted in high contact stresses, causing galling and possible seizure of the system when encountering vibrations and/or cross-axes motion.

The addition of link liner 38 with a low modulus of elasticity and adequate strength reduces contact stress and accommodates relative motion and cross-axis motion in link 26 while providing the strength required at the connection of link 26 and crank 30. Liner 38 allows for plastic deformation in liner 38 when cross-axial rotation of link 26 does happen, instead of the galling and fretting seen in past systems. This improves wear characteristics of the connection between crank 30 and link 26, improving life of linkage system 16 and valve 10.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A protective liner for a link in an actuation system, the liner comprising:
a link with a pin bore; and
a liner layer on an inner surface of the pin bore, wherein the liner material has a modulus of elasticity of less than 1×10⁵ and a load carrying capability of at least 10 Ksi (68.95 N/mm²).

2. The liner of claim 1, wherein the liner is about 0.01 inches (about 0.254 mm) to about 0.015 inches (about 0.381 mm) thick.

3. The liner of claim 1, wherein the liner layer is a filled plastic material.

4. The liner of claim 1, wherein the liner is molded to the link pin bore.

5. The liner of claim 1, wherein the liner is bonded to the link pin bore.

6. A linkage system for connecting an actuation system of a pneumatic air valve to a valve body, the linkage system comprising:
a link to be moved by the actuation system and with a pin bore with an inner surface;
a crank to connect to the link at the pin bore;
a shaft to connect to the crank and to the valve body to be rotated by the crank to open or close the valve; and
a link liner on the inner surface of the pin bore of the link, wherein the liner material has a modulus of elasticity of less than 1×10⁵ and a load carrying capability of at least 10 Ksi (68.95 N/mm²).

7. The linkage system of claim 6, wherein the liner is about 0.01 inches (about 0.254 mm) to about 0.015 inches (about 0.381 mm) thick.

8. The linkage system of claim 6, wherein the liner layer is a plastic material.

9. The linkage system of claim 6, wherein the liner is molded or bonded to the pin bore.

10. A pneumatic air valve comprising:
an actuation system;
a valve body;
a shaft connected to the valve body to open or shut the valve body; and
a linkage system connecting the actuation system to the valve body, wherein the linkage system includes a link connecting the linkage system to the actuation system to be moved by the actuation system and with a pin bore;
a crank connected to the link to be moved by the link and to the shaft to rotate the shaft, and a link liner in the pin bore with a low modulus of elasticity material and a high load carrying capability at the connection between the link and the crank.

11. The valve of claim 10, wherein the liner is about 0.01 inches (about 0.254 mm) to about 0.015 inches (about 0.381 mm) thick.

12. The valve of claim 10, wherein the liner layer is a plastic material.

13. The valve of claim 10, wherein the liner material has a modulus of elasticity of less than 1×10⁵.

14. The valve of claim 10, wherein the liner material has a load carrying capability of at least 10 Ksi (68.95 N/mm²).

15. The valve of claim 10, wherein the liner is molded or bonded to the link pin bore.

16. A method of forming a liner on a link, the method comprising:
providing a link having a pin bore; and
depositing a liner material on the inner surface of the bore, wherein the liner material has a modulus of elasticity of less than 1×10⁵ and a load carrying capability of at least 10 Ksi (68.95 N/mm²).

17. The method of claim 16, wherein the liner material is deposited on the pin bore by spraying the liner material onto the inner surface of the bore.

18. The method of claim 17, and further comprising:
machining out the sprayed on liner material.

19. The method of claim 16, wherein the liner material is deposited on the pin bore by molding a liner to the inner surface of the bore.

20. The method of claim 16, wherein the liner material is deposited on the pin bore by bonding a liner to the inner surface of the bore.
